(19) United States
(12) Patent Application Publication
(10) Pub. No.: US 2026/0220996 A1
(43) Pub. Date: Jul. 30, 2026

(54) ENGAGEMENT ASSEMBLY FOR GAMING CABINETS

(71) Applicant: Bluberi Gaming USA, Inc., Las Vegas, NV (US)

(72) Inventors: Mike BRENNAN, Las Vegas, NV (US); Mathieu PAQUETTE, Drummondville (CA); Éric BEAUDOIN, Drummondvill (CA)

(21) Appl. No.: 19/461,102

(22) Filed: Jan. 27, 2026

Related U.S. Application Data
(60) Provisional application No. 63/750,047, filed on Jan. 27, 2025.

(51) Int. Cl. G07F 17/32

(52) U.S. Cl. CPC G07F 17/3211

(57) ABSTRACT

An engagement assembly designed to enhance the visibility of multiple gaming cabinets includes a vertically extending pillar positioned between the cabinets. This pillar features several panels, each aligned behind and facing a gaming cabinet. Vertical light strips are installed between the panels, creating a dynamic visual effect. A controller is electrically connected to these light strips, enabling activation in response to specific events occurring on any of the gaming cabinets. This system effectively draws attention to the gaming area, enhancing the gaming experience by synchronizing visual cues with gameplay events.

### CROSS-REFERENCE TO RELATED APPLICATIONS

The present application claims priority to U.S. Provisional Patent Application Serial No. 63/750,047, filed Jan. 27, 2025 and entitled “Engagement Device for Gaming Cabinets,” the entirety of which is incorporated by reference herein.

### BACKGROUND OF THE DISCLOSURE

### 1. Field of the Disclosure

The present disclosure relates engagement assemblies for gaming machines, such as slot machines.

### 2. Related Art

This section provides background information related to the present disclosure which is not necessarily prior art.

Gaming machines, particularly slot machines, have long been a staple in casinos and other gaming establishments. These machines are designed to provide entertainment and the potential for monetary rewards, making them highly popular among patrons. Slot machines typically feature a variety of themes, graphics, and sound effects to attract and engage players. Over the years, advancements in technology have led to the development of more sophisticated and interactive gaming experiences, including video slots and multi-line machines. Despite these advancements, there remains a continuous need to better capture and maintain the attention of players of gaming machines.

### SUMMARY OF THE DISCLOSURE

According to an aspect of the disclosure, an engagement assembly for drawing attention to a plurality of gaming cabinets includes a pillar that extends about a vertical axis between a top and a bottom for being positioned between the plurality of gaming cabinets. The pillar has a plurality of panels that are each configured to be positioned behind, and to face one of the gaming cabinets. A plurality of light strips each extend vertically between two of the panels of the pillar. A controller is electrically connected to the light strips and configured to activate the plurality of light strips in response to a predetermined event on any of the gaming cabinets.

The engagement assembly provides increased excitement and draws attention to users in the gaming environment by prominently displaying a lighting effect based on an occurrence on any of the gaming machines.

### BRIEF DESCRIPTION OF THE DRAWINGS

These and other advantages of the present disclosure will be more readily understood by reference to the following description in combination with the accompanying drawings wherein:

FIG. 1 is perspective view of an embodiment of an engagement assembly positioned between a plurality of gaming cabinets, according to an aspect of the disclosure;

FIG. 2 is a perspective, exploded view of base cage and a subwoofer of the engagement assembly;

FIG. 3 is a perspective view of the engagement assembly;

FIG. 4 is a perspective, exploded view of a pillar and beacon housing of the engagement assembly;

FIG. 5 is a perspective, exploded view of the pillar and base cage of the engagement assembly;

FIG. 6 is a bottom, perspective view of the pillar and base cage of the engagement assembly;

FIG. 7 is a perspective view of controller connected to a shelf of a base cage of the engagement assembly;

FIG. 8 is a perspective view of the beacon housing of the engagement assembly;

FIG. 9 is a perspective, exploded view of the beacon housing and a sound box of the engagement assembly; and

FIG. 10 is a perspective, exploded view of the beacon housing of the engagement assembly.

### DETAILED DESCRIPTION OF THE ENABLING EMBODIMENTS

Example embodiments will now be described more fully with reference to the accompanying drawings. In general, the subject embodiments are directed to embodiments of an engagement assembly 10 for drawing attention to gaming cabinets 12 which include gaming machines, e.g., a slot machine or video poker machine. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

More particularly, referring to the figures, wherein like numerals indicate corresponding parts throughout the several views, embodiments of the engagement assembly 10 for drawing attention to gaming cabinets 12, such as those found in casinos, are shown. The engagement assembly 10 may be used in conjunction with various types of gaming cabinets 12, like slot machine or video poker cabinets.

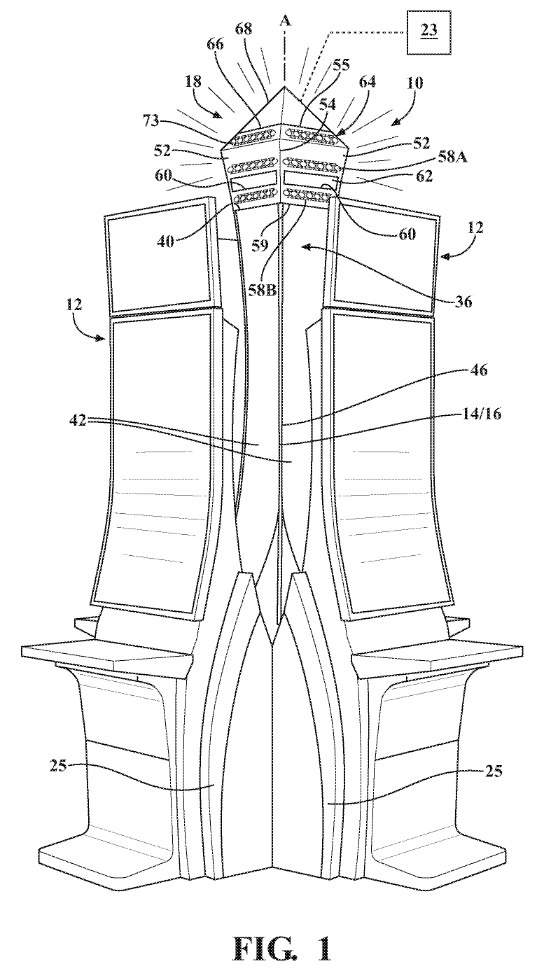

FIG. 1 presents an embodiment of the engagement assembly 10 positioned centrally relative to four gaming cabinets 12 which are positioned in a diamond / square shaped formation such that pairs of gaming cabinets 12 are positioned back-to-back relative to one another, with a space therebetween. The engagement assembly 10 could be used in conjunction with any number of gaming cabinets 12. The engagement assembly 10 occupies substantially the entire space between the gaming cabinets 12 and may be paired with other styles of dividers 25 to further close off the space between the cabinets 12. This arrangement inhibits users from depositing waste between the gaming cabinets 12.

As shown, corners 14 of the engagement assembly 10 are illuminated via edge light emitters 16, e.g., light strips 16, and a beacon housing 18 at a top of the engagement assembly 10 includes a light emitter 20 and a sound emitter 22. The light and sound emitters 20, 22 are electrically tied into the associated games in the gaming cabinets 12 and are configured to selectively activate via a controller 23 (shown in FIGS. 1 and 6-7) in fun and entertaining ways in response to special, predetermined events on the gaming machines. More particularly, the controller 23 sends and receives commands from the four (or more) gaming cabinets 12. The controller 23 may take various forms, such as a single board computer and may be connected to local and remote networks and the internet, and may include various input devices such as personal computers and smart devices for providing inputs to the controller 23. Standalone light and sound controllers may be used for respectively activating the light and sound emitters 20, 22. The controller 23 may have various inputs and outputs to provide connectivity to other cables / devices.

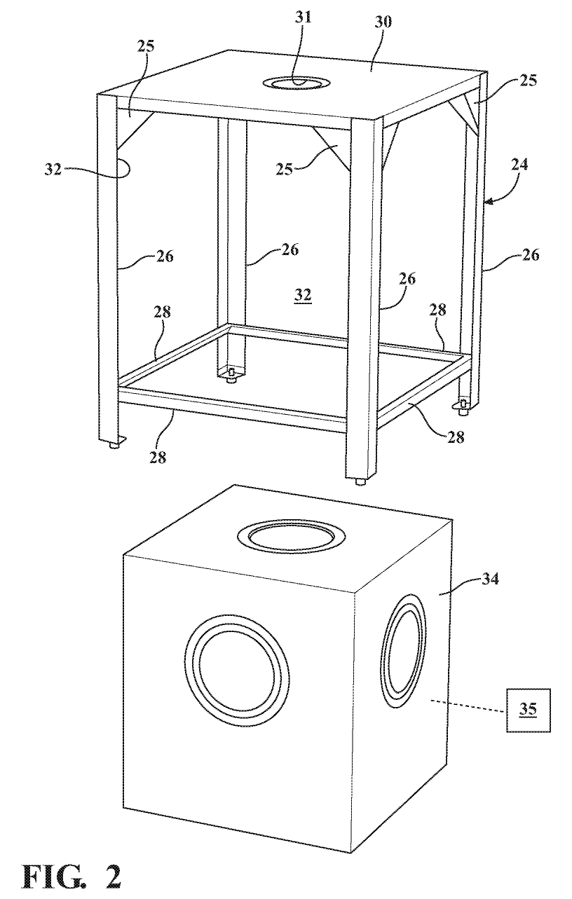

As best shown in FIGS. 2-3 and 5-6, the engagement assembly 10 includes a base cage 24 that generally has a box shape. The base cage 24 has four legs 26 that extend in a vertical direction to define four corners of the base cage 24. The base cage 24 also has four lower cross-bars 28 that each extend horizontally between two of the legs 26 at bottoms of the legs 26. The base cage 24 also has a shelf 30 that is connected to tops of the four legs 26. The shelf 30 has a cable window 31 through which cables 33 may pass. The base cage 24 defines a compartment 32 between the legs 26, shelf 30 and lower cross-bars 28. Flanges 25 are located at upper corners of the base cage 24 to provide stability for the based cage 24.

As shown in FIGS. 6-7, the controller 23 may be coupled to the bottom of shelf 30 such that it is contained and protected in the compartment 32 of the base cage 24. The controller 23 may be located at other locations and may take other forms.

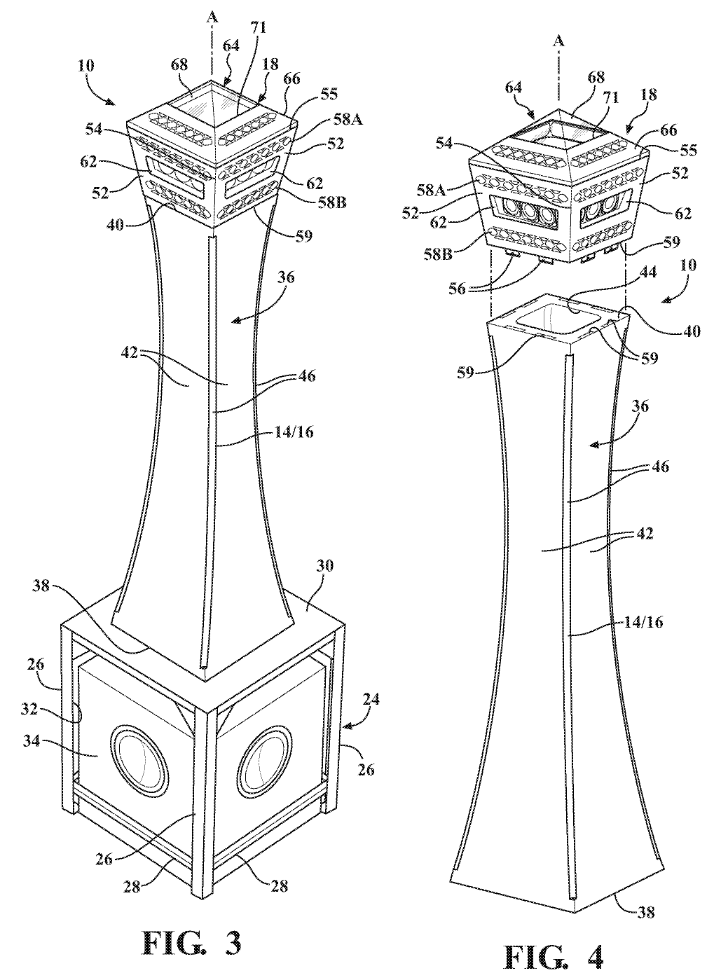

As best shown in FIGS. 2-3, a subwoofer 34 is contained in the compartment 32 of the base cage 24. More particularly, during assembly, the base cage 24 can be lowered down over the subwoofer 34 such that it surrounds the subwoofer 34. The subwoofer 34 may be one of many components configured to provide excitement to users during the occurrence of events in the games of the gaming cabinets 12 based on instructions from the controller 23. An amplifier 35 (schematically shown in FIG. 2) may be built into and electrically connected to the subwoofer 34 and the other sound emitters 22 to amplify sounds.

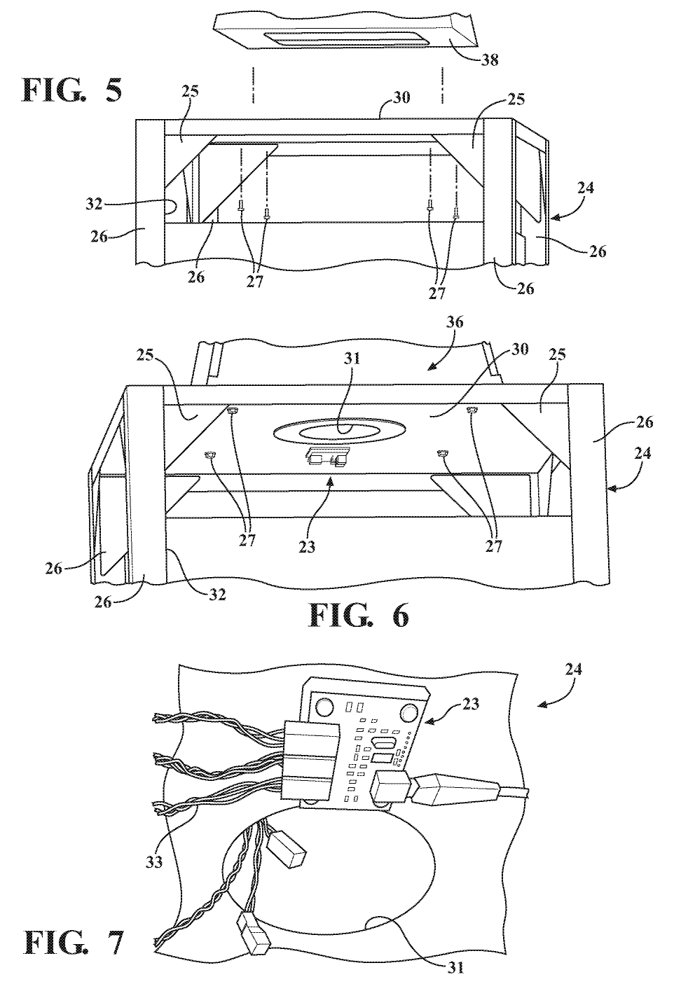

As shown in FIGS. 1 and 3-4, a pillar 36 is connected to a top of the shelf 30 of the base cage 24. The pillar 36 has a bottom end 38 that is mounted to the shelf 30 and extends upwardly about and along a central axis A to a top end 40. As shown in FIG. 5, the bottom end 38 may be connected to the shelf 30 in various ways, such as via an arrangement of fasteners 27. The pillar 36 is comprised of four panels 42 that are generally arranged in a square-shape along a plane which is perpendicular to the axis A. The panels 42 define a channel 44 extending therethrough for receiving connecting cables / wires. As shown in FIG. 1, the four gaming cabinets 12 are arranged such that each of the gaming cabinets 12 is positioned in front of one of the panels 42. Each of the four panels 42 has a concave shape and slopes toward an opposing one of the four panels 42. Other numbers of panels 42 could be used. Each of the panels 42 further has a pair of edges 46 that each have a concave shape, with the edges 46 of each of the panels 42 sloping toward one another. The panels 42 may be made of an at least partially reflective material such that they reflect light projected from behind the gaming cabinets 12. The edges 46 of each of the panels 42 engage one of the edges 45 of another of the panels 42 at a corner 14, with the corners 14 extending vertically.

A plurality of the edge light emitters 16 each extend along one of the corners 14 of the panels 42. The edge light emitters 16 may each be comprised of a light strip 16 made of an elongated substrate with a series of light emitting diodes connected to the substrate. Other types of illumination devices may be used.

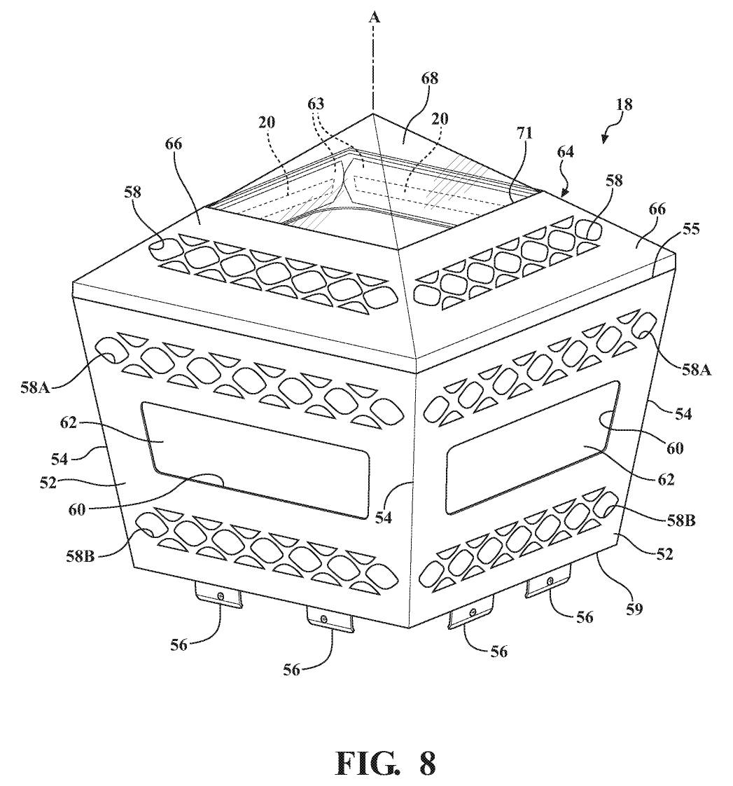

As best shown in FIGS. 1, 3-4 and 8-10, the beacon housing 18 is coupled to the top end 40 of the pillar 36. The beacon housing 18 defines a chamber 48. The beacon housing 18 has a lower wall 50 that extends along a horizontal plane that extends perpendicularly to the axis A. Four side walls 52 extend upwardly from the lower wall 50 and taper outwardly. The side walls 52 each have a pair of side edges 54 that each engage a side edge 54 of another of the side walls 52. The side walls 52 also each have a top edge 55 and a bottom edge 59. As best shown in FIG. 4, a series of tabs 56 extend from the bottom edges 59 of the side walls 52 for being received by slots 59 at the top end 40 of the pillar 36 to align and secure the beacon housing 18 to the pillar 36. The beacon housing 18 may be coupled to the pillar 36 in other ways. A number of beacon fasteners 57 are configured to connect the beacon housing 18 to the pillar 36.

Each of the side walls 52 defines first and second arrangements of lower grates 58A, 58B primarily for transmitting light therethrough, and at least one side window 60 positioned between both arrangements of lower grates 58 for emitting sound therethrough. The lower grates 58A, 58B are each comprised of a plurality of an array of orifices. According to the preferred embodiment, a mesh material 62 overlies the side window 60 which permits sound from the sound emitter 22 to pass therethrough while limiting a degree of light from the light emitter 20 to pass therethrough. According to other embodiments, the window 60 may be opened. Furthermore, a plurality of transparent panels 63, e.g., glass, are positioned behind the lower grates 58 in the chamber 48 of the beacon housing. The transparent panels 63 may have various colors to provide desired lighting effects. A plurality of light emitters 20 may be incorporated into the transparent panels 63. Non-transparent materials may alternatively be used for the panels 63.

The beacon housing 18 also has a generally pyramid-shaped lid portion 64. The lid portion 64 is comprised of a plurality of top panels 66 that are each connected to one of the top edges 55 of one of the side walls 52 and taper inwardly to the central axis A. Side edges of the top panels 66 are connected to one another to close the chamber 48. The top panels 66 terminate at an opening 71. A pyramid-shaped cap 68 of a transparent material, e.g., glass, is fixed to the top panels 66 to close the opening. The top panels 66 also define an array of upper grates 73, which are comprised of an array of orifices. Again, a plurality of transparent panels 63 of various colors, e.g., glass, are positioned behind the upper grates 58 in the chamber 48 of the beacon housing 18 and may house light emitters 20.

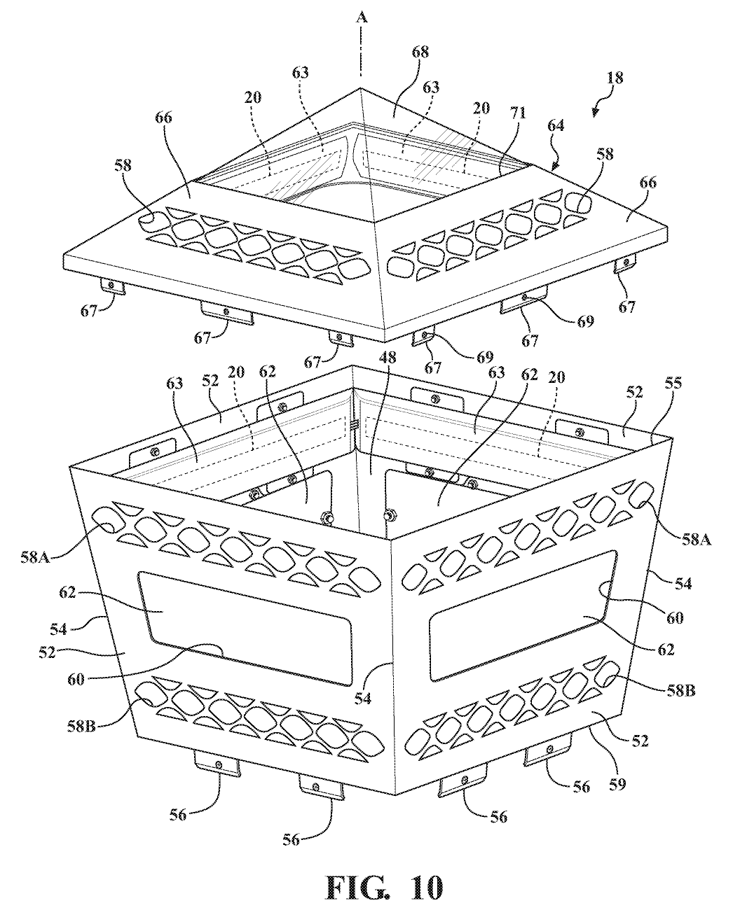

Alternatively, the top regions of the top panels 66 could be cut-out to define window at the top of the beacon housing, or a mesh material may be utilized to filter out light while permitting sound to pass therethrough. As best shown in FIG. 10, a series of tabs 67 extend from bottoms of the top panels 66 for being received by the side walls 52 and chamber 48 of the beacon housing 18 to align and secure the top panels 66 to the side walls 52. A series of top fasteners 69 also further secure the top panels 66 to the side walls 52.

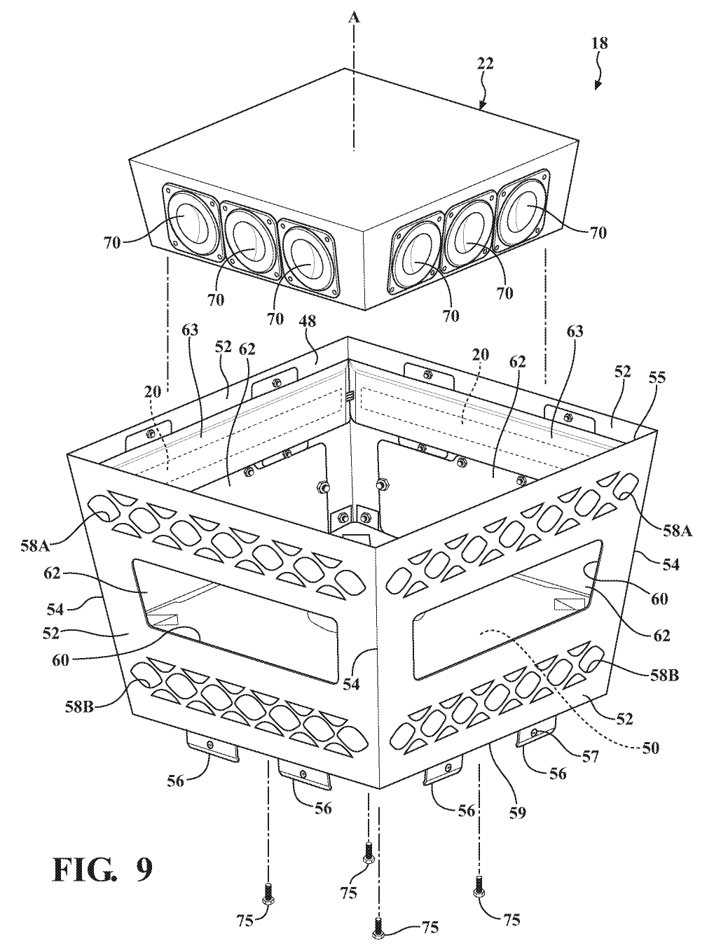

As best shown in FIG. 9, the sound emitter 22 is positioned in the chamber 48 of the beacon housing 18 for emitting sound through the side windows 60 of the beacon housing 18. As shown, the sound emitter 22 may be configured as a speaker box 22 with a plurality of speakers 70 located on all sides of the speaker box 22 such that sound is projected through the side windows 60 on all sides of the beacon housing 18. The sound emitter 22 may be secured to the lower wall 50 of the beacon housing 18 with a plurality of sound fasteners 75.

The sound emitter 22 is electrically connected with the controller 23 to selectively play sound through the sound emitter 22 based on occurrences on the gaming cabinet 12. Likewise, the light emitters 20 are electrically connected to the controller 23, and may be configured to rotate and/or flash in a strobe effect to simulate a beacon of a light house. The light emitter 20 may also include at least one holographic film for emitting a shape.

In view of the above, the engagement assembly 10 is uniquely configured to draw attention to, and maintain focus of patrons on the gaming cabinets 12. More particularly, the reflective pillar 36, the light emitters 16, 20 and sound emitters 22, 34 transmit sound and light to patrons at specific times based on instructions from the controller 23. For example, if a bonus or free game is triggered on the gaming machine of one of the gaming cabinets 12, this occurrence may be communicated to the engagement assembly 10, triggering lights and sounds not just for the engagement assembly 10, but also for the other gaming cabinets 12. Furthermore, the lights and sounds may be activated not just for the portions of the engagement assembly 10 adjacent to the specific winning gaming cabinet 12, but for the others as well. This creates a sense of excitement among all players of the gaming cabinets 12, and those surrounding the gaming cabinets 12, even when only one of the gaming cabinets 12 has triggered a special event. The other gaming cabinets 12 may also be configured to create celebratory effects, e.g., sound, lighting and video.

Obviously, many modifications and variations of the present disclosure are possible in light of the above teachings and may be practiced otherwise than as specifically described.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

What is claimed is:

1. An engagement assembly for drawing attention to a plurality of gaming cabinets, comprising:
a pillar extending about a vertical axis between a top and a bottom for being positioned between the plurality of gaming cabinets;
the pillar having a plurality of panels each configured to be positioned behind, and facing one of the gaming cabinets;
a plurality of light strips each extending vertically between two of the panels of the pillar; and
a controller electrically connected to the light strips and configured to activate the plurality of light strips in response to a predetermined event on any of the gaming cabinets.

2. The engagement assembly as set forth in claim 1, wherein each of the panels is positioned opposite another of the panels, and each of the panels has a concave shape between the top and bottom and sloping toward the opposite one of the panels, and wherein the light strips follow the concave shapes of the panels.

3. The engagement assembly as set forth in claim 2, wherein each of the panels further has a pair of edges that each have a concave shape with the edges of each of the panels sloping toward one another.

4. The engagement assembly as set forth in claim 3, wherein the plurality of panels includes four panels arranged generally in a square shape in cross-section along a plane being perpendicular to the axis such that edges of the panels together define four corners, and wherein the plurality of light strips includes four elongated light strips with each of the light strips located at one of the corners of the panels.

5. The engagement assembly as set forth in claim 4, further including a plurality of gaming cabinets with each of the gaming cabinets positioned in front of one of the panels.

6. The engagement assembly as set forth in claim 5, wherein the controller is configured to activate all of the plurality of light strips in response to the predetermined event occurring on any of the gaming cabinets.

7. The engagement assembly as set forth in claim 1, further including a beacon housing connected to the top of the pillar and defining a chamber, the beacon housing having a plurality of side walls each aligned with one of the panels of the beacon, the side walls each spanning between a top edge and a bottom edge, and the sidewalls each defining at least one window.

8. The engagement assembly as set forth in claim 7, wherein a light emitter is located in the chamber of the beacon housing to emit light though the at least one window of the side walls.

9. The engagement assembly as set forth in claim 7, wherein a sound emitter is located in the chamber of the beacon housing to emit sound through the at least one window of the side walls.

10. The engagement assembly as set forth in claim 7, wherein the beacon housing further includes a lid portion having a pyramid shape and connected to the top edge of the plurality of sidewalls to close the chamber of the beacon housing.

11. The engagement assembly as set forth in claim 10, wherein the lid portion is comprised of a plurality of top panels that are each connected to one of the top edges of the sidewalls and taper inwardly toward the central axis and terminate at an upper edge.

12. The engagement assembly as set forth in claim 11, wherein the upper edges of the top panels terminate at an opening.

13. The engagement assembly as set forth in claim 12, wherein the lid further has a cap being pyramid shaped and of a transparent material connected to the upper edges of the top panels to close the beacon housing while permitting light to pass through the cap.

14. The engagement assembly as set forth in claim 13, wherein the top panels each define an arrangement of upper grates, each of the upper grates defining an array of orifices to permit light and sound to pass therethrough.

15. The engagement assembly as set forth in claim 7 wherein each of the side walls further includes an arrangement of lower grates located above and below the at least one window, each of the lower grates defining an array of orifices to permit light and sound to pass therethrough.

16. The engagement assembly as set forth in claim 15, further including a transparent panel underlying each of the grates inside the chamber of the beacon housing.

17. The engagement assembly as set forth in claim 1, further including a base cage positioned under and supporting the pillar.

18. The engagement assembly as set forth in claim 17, wherein the base cage defines a compartment, and wherein a subwoofer is contained in the compartment for emitting low frequency acoustic energy in response to the predetermined event on any of the gaming cabinets.

19. The engagement assembly as set forth in claim 7, wherein the top of the pillar defines a plurality of channels, and wherein the bottom edge of each of the sidewalls of the beacon housing presents at least one tab configured to be received by the channels of the pillar to detachably couple the beacon housing to the pillar.

20. A system for drawing attention to a plurality of gaming cabinets, comprising:
four gaming cabinets arranged in a generally square shape;
a pillar extending about a vertical axis between a top and a bottom;
the pillar having a plurality of panels each configured to be positioned behind, and facing, a respective one of the plurality of gaming cabinets;
each of the panels being positioned opposite another of the panels and having a concave shape between the top and the bottom and sloping toward the opposite one of the panels;
each of the panels further having a pair of edges that each have a concave shape with the edges of each of the panels sloping toward one another;
the plurality of panels including four panels arranged generally in a square shape in cross-section along a plane perpendicular to the vertical axis such that edges of the panels together define four corners;
a plurality of light strips each extending vertically between two of the panels of the pillar;
the plurality of light strips including four elongated light strips with each of the elongated light strips located at a respective one of the four corners and following the concave shapes of the panels;
a controller electrically connected to the plurality of light strips and configured to activate all of the plurality of light strips in response to a predetermined event occurring on any of the plurality of gaming cabinets;
a beacon housing connected to the top of the pillar and defining a chamber, the beacon housing having a plurality of side walls each aligned with a respective one of the panels of the pillar, the side walls each spanning between a top edge and a bottom edge and each defining at least one window;
each of the side walls further including an arrangement of lower grates located above and below the at least one window, each of the lower grates defining an array of orifices to permit light and sound to pass therethrough;
a transparent panel underlying each of the grates inside the chamber of the beacon housing;
a lid portion having a pyramid shape connected to the top edges of the plurality of side walls to close the chamber of the beacon housing, the lid portion comprised of a plurality of top panels each connected to a respective one of the top edges of the side walls and tapering inwardly toward the vertical axis and terminating at an upper edge;
the upper edges of the top panels terminating at an opening;
the lid portion further including a cap that is pyramid-shaped and of a transparent material connected to the upper edges of the top panels to close the beacon housing while permitting light to pass through the cap;
the top panels each defining an arrangement of upper grates, each of the upper grates defining an array of orifices to permit light and sound to pass therethrough;
a light emitter located in the chamber of the beacon housing and configured to emit light through the at least one window of the side walls;
a sound emitter located in the chamber of the beacon housing and configured to emit sound through the at least one window of the side walls;
a base cage positioned under and supporting the pillar, the base cage defining a compartment;
a subwoofer contained in the compartment and configured to emit low frequency acoustic energy in response to the predetermined event on any of the plurality of gaming cabinets;
and a coupling interface between the pillar and the beacon housing in which a top of the pillar defines a plurality of channels and a bottom edge of each of the side walls of the beacon housing presents a tab configured to be received by the plurality of channels of the pillar to detachably couple the beacon housing to the pillar.
